(19) United States
(12) Patent Application Publication
(10) Pub. No.: US 2024/0357671 A1
(43) Pub. Date: Oct. 24, 2024

(54) DEVICE CONNECTION METHOD, DEVICE, AND STORAGE MEDIUM

(71) Applicant: GUANGDONG OPPO MOBILE TELECOMMUNICATIONS CORP., LTD., Dongguan (CN)

(72) Inventors: Fan LIU, Dongguan (CN); Zhiyi DENG, Dongguan (CN)

(73) Assignee: GUANGDONG OPPO MOBILE TELECOMMUNICATIONS CORP., LTD., Dongguan (CN)

(21) Appl. No.: 18/758,601

(22) Filed: Jun. 28, 2024

Related U.S. Application Data
(63) Continuation of application No. PCT/CN2022/139643, filed on Dec. 16, 2022.

(30) Foreign Application Priority Data
Dec. 31, 2021 (CN) 202111665744.1

(51) Int. Cl. H04W 76/10; H04W 52/02

(52) U.S. Cl. CPC H04W 76/10; H04W 52/0225

(57) ABSTRACT

A device connection method, a device, and a storage medium. The method is performed by an electronic device; wherein the electronic device supports operation of a first system and a second system. The method includes: sending, by the second system, a wireless scanning request to the first system; performing, by the first system, wireless signal scanning based on the wireless scanning request; sending, by the first system, a connection establishment request to the second system in a case where a target wireless signal is scanned and detected; and establishing, by the second system, a wireless communication connection with a target external device based on the connection establishment request; wherein the target external device is an external device that transmits the target wireless signal.

### CROSS-REFERENCE TO RELATED APPLICATIONS

The present application is a continuation-application of International (PCT) Patent Application No. PCT/CN2022/139643, filed on Dec. 16, 2022, which claims priority of Chinese Patent Application No. 202111665744.1, filed on Dec. 31, 2021, the entire contents of which are hereby incorporated by reference in their entirety.

### TECHNICAL FIELD

The present disclosure relates to the technical field of electronic devices, and in particular to a device connection method, an apparatus, a device, a storage medium, and a program product.

### BACKGROUND

Sensorless unlocking refers to a solution where a vehicle owner realizes a sensorless unlocking of an external device and a sensorless locking of the external device far away, by carrying an electronic device and approaching the external device. The above process is accomplished by the electronic device in cooperation with a control system in the external device, without manual operation by the user.

In the related art, a device connection application in the electronic device runs in the background of the system and always turns on a signal scanning function (such as Bluetooth scanning function). When the electronic device scans a wireless signal emitted by the external device, it establishes a communication connection with the external device and sends a request to the external device through the communication connection to unlock the device. However, when the user does not use the electronic device for a long period of time and the system goes into dormant, the electronic device is unable to carry out signal scanning, which results in the electronic device not being able to connect to the external device in time when the signal scanning is interrupted, requiring the user to manually wake up the system and the program again.

### SUMMARY OF THE DISCLOSURE

The embodiments of the present disclosure provide a device connection method, an apparatus, a device, a storage medium, and a program product. The described technical programs are as followed.

In a first aspect, the present disclosure provides a device connection method, performed by an electronic device; wherein the electronic device supports operation of a first system and a second system;
wherein the device connection method includes:
sending, by the second system, a wireless scanning request to the first system;
performing, by the first system, wireless signal scanning based on the wireless scanning request;
sending, by the first system, a connection establishment request to the second system in a case where a target wireless signal is scanned and detected; and
establishing, by the second system, a wireless communication connection with a target external device based on the connection establishment request; wherein the target external device is an external device that transmits the target wireless signal.

In a second aspect, the present disclosure provides a device connection apparatus, performed by an electronic device; wherein the electronic device supports operation of a first system and a second system;
wherein the device connection apparatus includes:
a second system module, configured to send a wireless scanning request to a first system module; and
the first system module, configured to perform wireless signal scanning based on the wireless scanning request;
wherein the first system module is further configured to send a connection establishment request to the second system module in a case where a target wireless signal is scanned and detected;
the second system module is further configured to establish a wireless communication connection with a target external device based on the connection establishment request; wherein the target external device is an external device that transmits the target wireless signal.

In a third aspect, the present disclosure provides an electronic device, including a processor and a memory; wherein the memory stores at least one instruction, the at least one instruction being configured to be executed by the processor to cause the electronic device to perform the method as above.

In a fourth aspect, the present disclosure provides a computer-readable storage medium, storing at least one instruction; wherein the at least one instruction is configured to be executed by a processor to cause an electronic device to perform the method as above.

In a fifth aspect, the present disclosure provides a computer program product or a computer program, including computer instructions; wherein the computer instructions are stored in a computer-readable storage medium; when a processor of an electronic device reads the computer instructions from the computer-readable storage medium, the processor executes the computer instructions to cause the electronic device to perform the method as above.

### BRIEF DESCRIPTION OF THE DRAWINGS

FIG. 1 is a schematic view of a second processor corresponding to a dual-core communication software framework according to some embodiments of the present disclosure.

FIG. 2 is a schematic view of a first processor corresponding to a dual-core communication software framework according to some embodiments of the present disclosure.

FIG. 3 is a schematic view of an implementation environment according to some embodiments of the present disclosure.

FIG. 4 is a flowchart of a device connection method according to some embodiments of the present disclosure.

FIG. 5 is a system framework for a smartwatch and an in-vehicle management machine according to some embodiments of the present disclosure.

FIG. 6 is a flowchart of a device connection method according to other embodiments of the present disclosure.

FIG. 7 is a software framework for a smartwatch and an in-vehicle management machine according to some embodiments of the present disclosure.

FIG. 8 is a flowchart of a device connection method according to further other embodiments of the present disclosure.

FIG. 9 is a timing diagram of a connection interaction between a smartwatch and a vehicle according to some embodiments of the present disclosure.

FIG. 10 is a structural block diagram of a device connection apparatus according to some embodiments of the present disclosure.

FIG. 11 is a structural block diagram of an electronic device according to some embodiments of the present disclosure.

### DETAILED DESCRIPTION

In order to make the purpose, technical solutions, and advantages of the present disclosure clearer, the following embodiments of the present disclosure will be described in further detail in conjunction with the accompanying drawings.

References to “more than one” in this document refer to two or more than two. The terms of “and/or” describe an association relationship of associated objects and indicate that three kinds of relationships may exist. For example, A and/or B may be indicated as: A alone, both A and B, and B alone. The character “/” generally indicates that the associated objects are in an “or” relationship.

In the related art, a single processor is arranged in the electronic device, and all system events generated during the operation of the electronic device are processed by an operating system running on the processor. Therefore, the processor is required to have a strong data processing capability and maintain a working state during the operation of the electronic device, especially for tasks required to be performed continuously for a long time such as scanning of wireless signals and sending of heartbeat packets, in which case the processor is required to keep in a wake-up state. However, in the course of daily use, the user usually does not use the electronic device continuously, and in order to reduce the power consumption of the device, the electronic device will enter a dormant state after not receiving user operations for a period of time, and the system cannot process events in the dormant state. Regarding the device connection task, after the electronic device enters the dormant state, it is unable to perform wireless signal scanning, which results in the electronic device not being able to connect to the external device in time when the signal scanning is interrupted, requiring the user to manually wake up the system and the program again. In this way, the user's experience is affected.

In order to reduce the power consumption of the device while avoiding the impact on the connection task of the device, in some embodiments, the electronic device is arranged with at least a first processor and a second processor responsible for different processing performance and power consumption, which are configured to run a first system and a second system (i.e., dual-core dual-system) respectively, and a set of system switching mechanisms is designed for the dual-core dual-system.

During the operation of the electronic device, events with low-performance processing requirements are processed through the first system running on a low-power processor, and a high-power processor is kept in a dormant state (accordingly, the second system running on the high-power processor is in a dormant state), which realizes the basic functions of the electronic device and reduces the power consumption of the electronic device at the same time. When there is an event with high-performance processing requirements (such as starting an application), the high-power processor is awakened and the second system is switched to process the event to ensure that the triggered event can be responded to and processed in a timely manner, thereby meet the performance requirements of the electronic device.

During the operation of the electronic device, some applications running on the high-power consumption system are required to maintain communication connections with other devices. For example, a vehicle application running on the high-power system is required to maintain a Bluetooth connection with an in-vehicle management machine in order to realize specific functions (e.g., vehicle unlocking, locking, and checking vehicle state). In this scenario, the high-power system is required to stay awake (keeps in the wake-up state) for a long time, and the processes of the vehicle application is required to stay resident for a long time. However, the high-power consumption system being in the wake-up state for a long time and the processes of the vehicle application being resident for a long time can lead to an increase in power consumption of the electronic device.

In some embodiments of the present disclosure, when the second system is required to perform a task of establishing a communication connection with a target external device, the second system sends a wireless scanning request to the first system, which is responsible for scanning the wireless signals; the first system wakes up the second system to continue to perform the task of establishing the communication connection after scanning and detecting a target wireless signal, which eliminates the need for the second system to remain in the wake-up state for signal scanning. Compared to electronic devices in the related art, it is possible to avoid a situation in which the functions of scanning wireless signals and connecting to the external device are disabled caused by the system being dormant because the user has not used the electronic device for a long period of time, which may improve the connection efficiency of the device and avoids a situation in which the user has to manually wake up the system again after the system has been dormant for a connection to the external device, simplifying the operation of the user. In addition, the operating power consumption of the first system is lower than the operating power consumption of the second system, and the electronic device delivers the signal scanning task to the low-power system for execution, such that the high-power system can enter the dormant state to reduce the overall operating power consumption of the electronic device.

In some embodiments of the present disclosure, the first processor and the second processor operate asynchronously, and the first system and the second system are required to realize system communication (or known as dual-core communication). In an application scenario, the first system is a Real Time Operating System (RTOS) running on a Micro Controller Unit (MCU), and the second system is an Android operating system running on a Central Processing Unit (CPU).

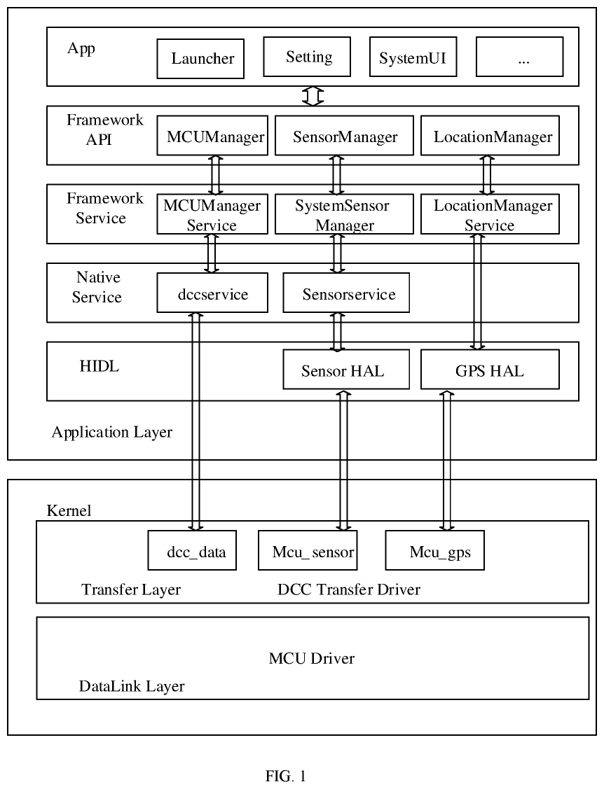

As shown in FIG. 1, a dual-core communication software framework for the Android operating system is illustrated in some embodiments of the present disclosure. The dual-core communication software framework follows the design principle of “low coupling, high reliability, high reuse”, including module developments of Kernel, HIDL (hardware abstraction layer interface description language), Native Service, Framework Service, Framework API, and APP modules.

The APP module includes functional modules such as Launcher, Setting, and System UI; the Framework API module includes management modules such as MCU Manager, Sensor Manager, Location Manager; the Framework Service module includes service modules such as MCU Manager Service, System Sensor Manager, Location Manager Service; the Native Service module includes service modules such as dcc service and Sensor service; the HIDL module includes modules such as Sensor HAL (Hardware Abstraction Layer) and GPS HAL; the Kernel module includes dcc_data, Mcu_sensor, Mcu_gps, and other DCC Transfer Driver.

A transfer layer, as an interface layer connecting upper and lower layers in the dual-core communication software framework, shields the transmission details of the communication of the lower layer of the system (data link layer) to an application layer, and provides service channels for the application scenarios; the application layer, as the main body of the service provision, responds to human-computer interactions and transfers the data generated in the process of human-computer interactions through the transfer layer, as well as responds to external data requests.

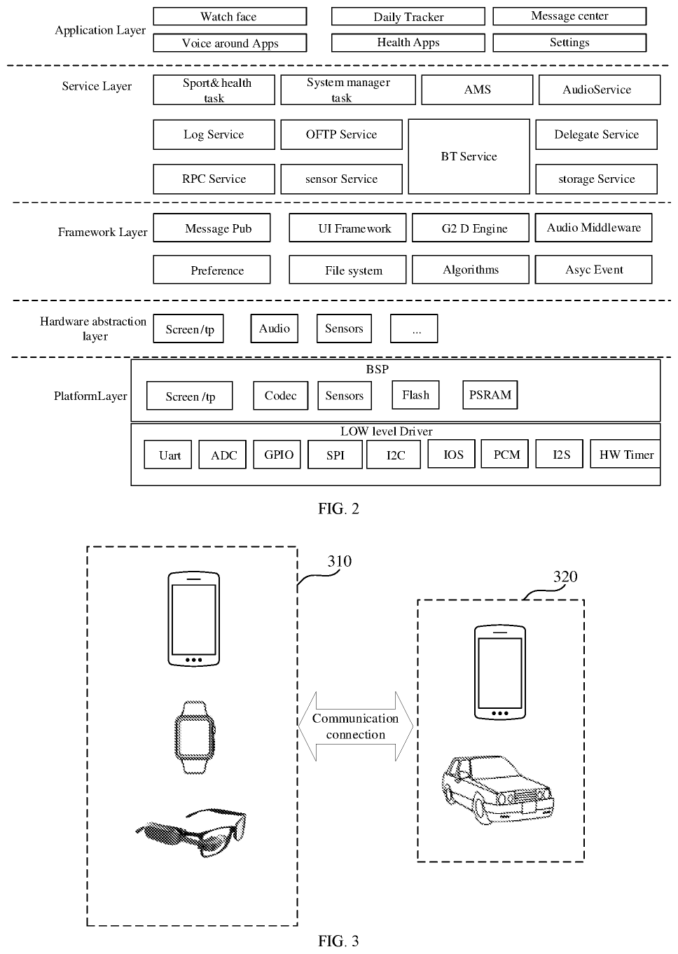

The RTOS is designed using the principle of peer-to-peer. As an example, the electronic device is a smartwatch, as shown in FIG. 2, which illustrates a dual-core communication software framework for RTOS illustrated in some embodiments of the present disclosure.

The dual-core communication software framework for RTOS is divided into an application layer, a service layer, a framework layer, a hardware abstraction layer, and a platform layer.

The application layer includes watch face, Daily Tracker, Message center, Voice around Apps, Health Apps, Settings, and other application modules; the service layer includes Sport& Health task, System manager task, AMS (Activity Management Service), Audio Service, Log Service, OFTP (Odette File Transfer Protocol) Service, BT (Bluetooth) Service, Bluetooth Service, Delegate Service, RPC (Remote Procedure Call) Service, sensor Service, storage Service, and other service modules; the framework layer includes Message Pub, UI Framework, G2D Engine, Audio Middleware, Preference, File system, Algorithms, Asyc Event (asynchronous events within process), and other framework modules; the Hardware abstraction layer includes hardware abstraction modules such as Screen/TP (Screen/Touch Panel) and sensors; the Platform layer includes BSP (Board Support Package) and LOW level Driver, where the BSP includes Screen/TP, Codec, sensors, Flash, PSRAM (Pseudo-Static Random Memory), etc., and the LOW level Driver includes Uart (Universal Asynchronous Transceiver), ADC (Analog to Digital Converter), GPIO (General Purpose Input/Output), SPI (Serial Peripheral Interface), I2C (Integrated Circuit Bus), IOS (Input Output System), PCM (Pulse Coded Modulation), I2S (Integrated Audio Bus), HW Timer (Hardware Timer).

It should be noted that the above dual-core communication software framework is only intended for schematic illustration, and those skilled in the art may add, delete, or modify the above framework according to actual needs. The embodiments of the present disclosure do not constitute a limitation on the specific structure of the dual-core communication software framework.

Referring to FIG. 3, FIG. 3 is a schematic view of an implementation environment according to some embodiments of the present disclosure, which includes an electronic device 310 and an external device 320.

The electronic device 310 supports running a first system and a second system (with different power consumption and different processing performance), which may be a device with a small battery capacity and high endurance requirements, such as a smartphone, a tablet, a wearable device, etc. The electronic device 310 is illustrated schematically in FIG. 3 as an example of a smartphone, a smartwatch, and smart glasses.

In some embodiments of the present disclosure, the electronic device 310 is arranged with a communication component, through which the electronic device 310 can establish a communication connection with another device and perform data communication. In some embodiments, the communication component may be a Bluetooth component, a Wi-Fi component, etc., without limitation herein.

In some embodiments, the communication component (dual communication component) is mounted on each processor (or processor core) running a corresponding one of the first system and the second system, and each of the first system and the second system may communicate data through a corresponding communication component. Or, the communication component (single communication component) is mounted on a processor (or processor core) running a low-power system; the low-power system maintains a wake-up state during operation of the electronic device, and each system communicates data through the communication component corresponding to the low-power system.

The external device 320 is a device that has a communication connection with the electronic device 310. The external device 320 is illustrated schematically in FIG. 3 as an example of a smartphone or an in-vehicle management machine of a vehicle. In some embodiment of the present disclosure, the first system in the electronic device 310 continuously scans for wireless signals, and when the first system detects a wireless signal emitted by the external device 320, the second system is awakened to establish a communication connection with the external device 320, where the first system may be the low-power system.

In an application scenario, the electronic device 310 is a smartwatch and the external device 320 is an in-vehicle management machine, and the smartwatch is required to continuously scan for wireless signals in the vicinity before connecting to the in-vehicle management machine. When the smartwatch detects a wireless signal emitted by the in-vehicle management machine, it establishes a communication connection with the in-vehicle management machine based on the wireless signal. The smartwatch accomplishes the above communication connection by running the first system and the second system, where the scanning task upon the wireless signal is performed by the first system based on a scanning parameter sent by the second system. After the first system scans the target wireless signal emitted by the in-vehicle management machine, it sends a connection establishment request to the second system, and the second system interacts with the in-vehicle management machine based on the connection establishment request and establishes the communication connection.

In the following embodiments, the device connection method is illustrated as an example to be performed by the electronic device 310.

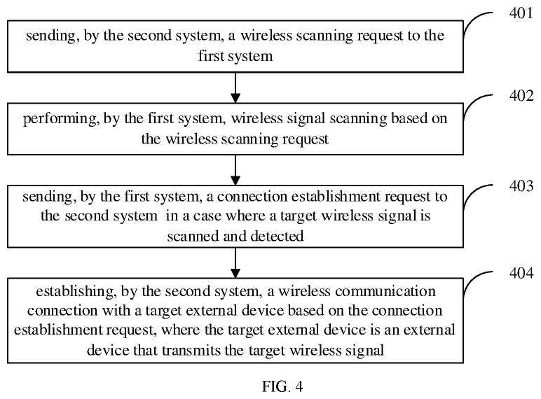

Referring to FIG. 4, FIG. 4 is a flowchart of a device connection method according to some embodiments of the present disclosure. The present embodiments are illustrated as an example in which the method is applied to an electronic device, and the electronic device supports operation of a first system and a second system. The method may include the following operations at blocks illustrated in FIG. 4.

At block 401: sending, by the second system, a wireless scanning request to the first system.

In some embodiments, the electronic device has the function of remotely controlling an external device, for example, remotely controlling the turning on and off of an intelligent terminal such as a vehicle, a television, an air conditioner, etc. In order to realize the device control via wireless signals by the electronic device, the electronic device first needs to establish a communication connection with the external device before sending data or commands to the external device. The device connection process mainly includes several stages such as signal scanning, signal recognition, and communication connection establishment. Among them, the signal scanning is continuously carried out by the connection initiator, for example, the electronic device scans the wireless signal every 1 ms until it scans and detects a wireless signal emitted by the external device to be connected. As a result, when the electronic device is far away from the external device or the signal strength of the external device is weaker, the electronic device requires a longer scanning time.

During operation of the second system, the second system listens in real time for a device connection event (e.g., an enabling operation upon a device connection program), and when the device connection event is listened to, the second system sends a wireless scanning request to the first system. The wireless scan request contains information for indicating a signal scanning method to inform the first system how to perform the wireless signal scanning and how to recognize the signal of the external device to be connected. In some embodiments, after the second system sends the wireless scanning request to the first system, the second system may stop running an application related to device connection or enter a dormant state based on a usage condition of the user, and the first system is responsible for continuously scanning wireless signals. Specifically, the second system is arranged with a dual-system communication interface, the dual-system communication interface being an interface for communication between the first system and the second system in the electronic device, and the second system sends the wireless scanning request to the first system via the dual-system communication interface.

In some embodiments, the electronic device is arranged with a first processor and a second processor, where the processing performance of the first processor is lower than the processing performance of the second processor (i.e., the processing power and the processing speed of the first processor are lower than those of the second processor), and the power consumption of the first processor is lower than the power consumption of the second processor. Based on the fact that the working time of the first system is longer than the working time of the second system, and that the first system has lower requirements for a corresponding processor in the process of device connection, the first system may be operated by the first processor and the second system may be operated by the second processor. Accordingly, the second system (operated by the second processor) is able to process the events that can be processed by the first system (operated by the first processor), while the first system is not necessarily able to process the events that can be processed by the second system.

In other embodiments, the electronic device may be arranged with a single processor, with the first system and the second system running on different cores of the processor, where the processing performance of the core running the second system is higher than the processing performance of the core running the first system.

For example, when the electronic device is a smartwatch, for example, the first processor is an MCU, the second processor is a CPU, the first system is an RTOS, and the second system is an Android system. Accordingly, the events that can be processed by the first system include dial display, notification message display, wireless signal scanning, sending and receiving of signals and data, and other scenarios that require low processing performance or weak interaction scenarios; and the events that can be processed by the second system include incoming call answering, message replying, dial editing, function setting, communication upper layer business, and other scenarios that require high processing performance or strong interaction scenarios.

For a dual-system electronic device, the two systems are responsible for different events and their processing performance for the events is different. Therefore, there is usually a certain difference in the operating power consumption between the two systems. In some embodiments, the operating power consumption of the second system is higher than the operating power consumption of the first system. The electronic device tends to keep the first system in the wake-up state for long periods of time, while the second system switches to the wake-up state only when processing a particular task. Since the need for remote control of external devices involves complex wireless communication operations, this particular task is usually required to be performed by a system with higher processing performance. However, by delivering the signal scanning to the first system for execution, on the one hand, the electronic device is able to carry out the signal scanning without interruption to connect with the external device during the time when the second system is carrying out other events or enters into the dormant state; on the other hand, by adopting a low-power system to carry out the signal scanning without the need for the second system to continuously run the power-consuming application for connecting with the device in the foreground or the background, it is possible to reduce the overall power consumption of the electronic device and improve the endurance of the electronic device.

At block 402: performing, by the first system, wireless signal scanning based on the wireless scanning request.

Accordingly, after receiving the wireless scanning request sent by the second system, the first system carries out the wireless signal scanning via a wireless communication module based on the signal scanning method, the device signal identification method, and other relevant information indicated by the wireless scanning request.

Schematically, the first system is arranged with a low-power Bluetooth module. When receiving the Bluetooth scanning request sent by the second system, the first system activates the Bluetooth module to perform the Bluetooth signal scanning.

At block 403: sending, by the first system, a connection establishment request to the second system in a case where a target wireless signal is scanned and detected.

In some embodiments, the first system performs the wireless signal scanning according to a certain signal scanning frequency (scanning interval) and a signal scanning duration (scanning window). When the target wireless signal indicated by the wireless scanning request is scanned, the first system sends the connection establishment request to the second system to inform the second system to request the establishment of a communication connection to the transmitter of the target wireless signal. Specifically, the first system sends the connection establishment request to the second system via the dual-system communication interface.

At block 404: establishing, by the second system, a wireless communication connection with a target external device based on the connection establishment request, where the target external device is an external device that transmits the target wireless signal.

Accordingly, after receiving the connection establishment request sent by the first system, the second system pulls up a process of the device connection program and interacts with the target external device corresponding to the target wireless signal through the device connection program, so as to establish the wireless communication connection.

In some embodiments, the target wireless signal emitted by the target external device carries information for indicating a communication mode, such as a Media Access Control (MAC) address, which is included in the connection establishment request sent by the first system to the second system, such that the second system establishes a wireless communication connection with the target external device based on the connection establishment request.

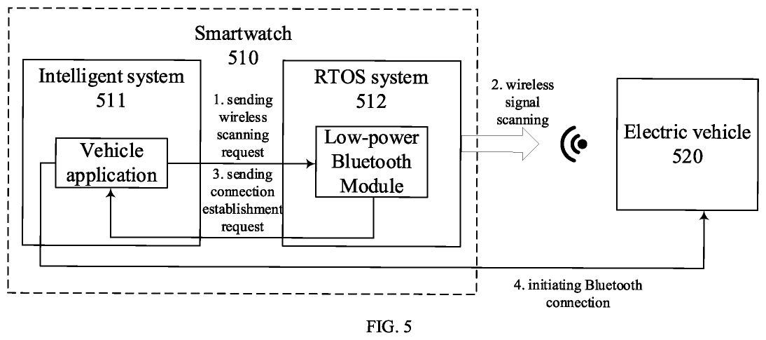

Schematically, FIG. 5 illustrates a process of connecting a smartwatch to an electric vehicle. The smartwatch 510 includes an intelligent system 511 (the second system) and an RTOS system 512 (the first system). The connection process includes: 1). the intelligent system 511 sends a wireless scanning request to a low-power Bluetooth module in the RTOS system 512 through a vehicle application; 2). the RTOS system 512 scans for wireless signals through the low-power Bluetooth module; 3). when scanning and detecting a wireless signal of the electric vehicle 520, the RTOS system 512 sends a connection establishment request to the vehicle application in the intelligent system 511; and 4). the intelligent system 511 initiates a Bluetooth connection to the electric vehicle 520 through the vehicle application.

In summary, in the embodiments of the present disclosure, the second system sends a wireless scanning request to the first system, such that the first system is responsible for signal scanning, and the electronic device can still scan the wireless signals of the external device through the first system even when the second system enters into the dormant state; the first system sends a notification to the second system when scanning and detecting the target wireless signal, such that there is no need for the second system to remain in the wake-up state for a long period of time and the device connection process can still be carried out. The above design may avoid a situation in which the functions of scanning wireless signals and connecting to the external device are disabled caused by the system being dormant because the user has not used the electronic device for a long period of time, which may improve the connection efficiency of the device and avoids a situation in which the user has to manually wake up the system again after the system has been dormant for a connection to the external device, simplifying the operation of the user.

In some embodiments, a scanning parameter is included in the wireless scanning request, and the first system scans the wireless signal based on the wireless scanning parameter, including:
performing, by the first system, the wireless signal scanning based on a scanning method indicated by the scanning parameter.

In some embodiments, the first system is arranged with a scanning strategy, and the scanning strategy is configured to indicate a condition to be satisfied when performing the wireless signal scanning, including:
in a case where the scanning strategy is satisfied, performing, by the first system, the wireless signal scanning based on a scanning method indicated by the scanning parameter; and
in a case where the scanning strategy is not satisfied, stopping, by the first system, the wireless signal scanning.

In some embodiments, the scanning strategy includes at least one of a sleep strategy, a wearing strategy, a movement strategy, a first pedometer strategy, and a second pedometer strategy;
the sleep strategy is configured to instruct the wireless signal scanning to be performed in a non-sleeping scenario;
the wearing strategy is configured to instruct the wireless signal scanning to be performed in a case where the electronic device is in a worn state;
the movement strategy is configured to instruct the wireless signal scanning to be performed in a non-motion scenario;
the first pedometer strategy is configured to instruct the wireless signal scanning to be performed when an increment of the step count reaches a threshold value;
the second pedometer strategy is configured to instruct the wireless signal scanning to be performed for a target duration of time after the step count stops changing.

In some embodiments, the first system performs the wireless signal scanning based on the scanning method indicated by the scanning parameter, in a case where the scanning strategy is satisfied, including:
determining, by the first system, a target scanning strategy that is in an on state based on strategy indication information; where the strategy indication information is configured to indicate an on/off state of a scanning strategy, and the strategy indication information is provided by the second system; and
in a case where the target scanning strategy is satisfied, performing, by the first system, the wireless signal scanning based on the scanning method indicated by the scanning parameter;
the first system stops the wireless signal scanning in a case where the scanning strategy is not satisfied, including:
in a case where the target scanning strategy is not satisfied, stopping, by the first system, the wireless signal scanning.

In some embodiments, in a case where the target wireless signal is scanned and detected, the first system sends the connection establishment request to the second system, including:
obtaining, by the first system, a device identification included in the wireless signal; and
in a case where the device identification is a target device identification, sending, by the first system, the connection establishment request to the second system; where the target device identification is an identification of the target external device, and the target device identification is provided by the second system.

In some embodiments, in a case where the connection establishment request includes the target wireless signal, the second system establishes the wireless communication connection with the target external device based on the connection establishment request, including:
obtaining, by the second system, a target device parameter of the target external device based on the target wireless signal;
sending, by the second system, a wireless connection request to the target external device based on the target device parameter; and
in response to a request acceptance response from the target external device, establishing, by the second system, the wireless communication connection with the target external device.

In some embodiments, the second system sends a positioning broadcast, and the positioning broadcast is configured for the target external device to adjust a device state based on the received positioning broadcast.

In some embodiments, in a case where the target external device is an in-vehicle management machine, the positioning broadcast is configured for the in-vehicle management machine to determine a device distance from the electronic device based on the positioning broadcast, including:
in a case where the device distance is less than a distance threshold, setting, by the in-vehicle management machine, the vehicle to an unlocked state; and
in a case where the device distance is greater than the distance threshold, setting, by the in-vehicle management machine, the vehicle to a locked state.

In some embodiments, in a case where the target wireless signal is scanned and detected, the first system sends the connection establishment request to the second system, including:
in a case where the target wireless signal is scanned and detected and the second system is in a dormant state, waking up, by the first system, the second system; and
in a case where the second system is in a wake-up state, sending, by the first system, the connection establishment request to the second system.

In some embodiments, in a case where the first system and the second system share a wireless communication component of the electronic device, further including:
sending, by the second system, a heartbeat packet sending request to the first system; and
sending, by the first system, a heartbeat packet to the target external device based on the heartbeat packet sending request; where the heartbeat packet is configured to maintain the wireless communication connection with the target external device.

In some embodiments, the first system operates at a lower power consumption than the second system.

In some embodiments, the wireless scanning request sent by the second system to the first system contains information for indicating a scanning method and information for identifying the target external device, such that the first system can scan for wireless signals in accordance with the scanning method indicated by the wireless scanning request and to identify the target wireless signal emitted by the target external device.

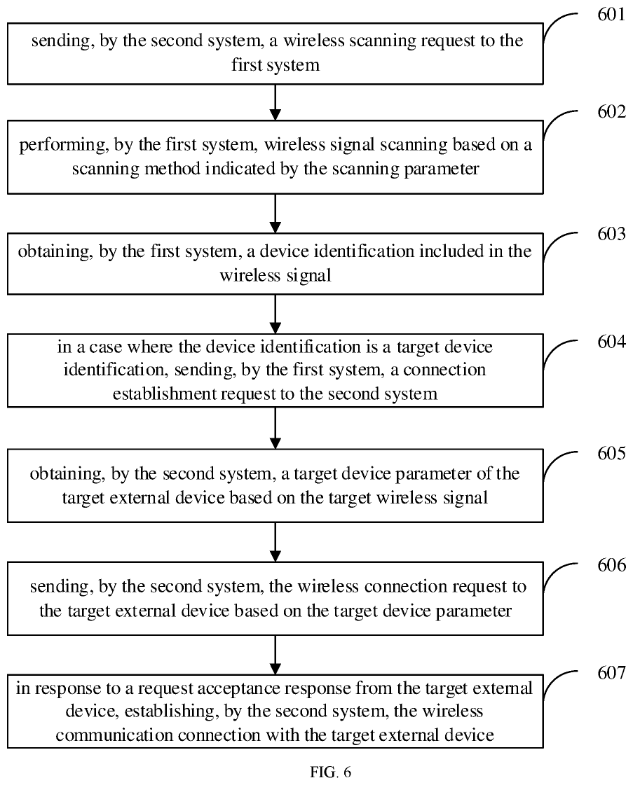

Referring to FIG. 6, FIG. 6 is a flowchart of a device connection method according to other embodiments of the present disclosure. The present embodiments are illustrated as an example in which the method is applied to an electronic device, and the electronic device supports operation of a first system and a second system. The method may include the following operations at blocks illustrated in FIG. 6.

At block 601: sending, by the second system, a wireless scanning request to the first system.

In some embodiments, the wireless scanning request sent by the second system contains a scanning parameter, where the scanning parameter is configured to indicate a scanning method of the wireless signal.

In some embodiments, the second system sends the wireless scanning request containing the scanning parameter to the first system at a first time in which a connection with the target external device is made, or, the second system sends the wireless scanning request containing the scanning parameter each time the connection of the target device is made, which is not limited herein.

Schematically, the scanning parameter sent by the second system includes a scanning window, a scanning interval, a distribution mode, and a filtering type. As shown in Table 1, which illustrates data such as the scanning parameter sent by the second system to the first system when the electronic device scans the wireless signals of the target vehicle.

TABLE 1

| Field Name | Data Type | Description |
|---|---|---|
| manufacture | 32-bit integer | Manufacturer; representing |
| | (Integer32, INT32) | the vehicle manufacturer, |
| | | and different value |
| | | corresponding to different |
| | | vehicle manufacturers |
| ServiceUuid | 8-bit unsigned integer | Unique information used to |
| | (Unsigned INT, UINT8) | identify the vehicle |
| scanWindow | INT32 | Scanning window (ms) |
| SacnInterval | INT32 | Scanning interval (ms) |
| DeliverMode | INT32 | Distribution mode |
| FilterType | INT32 | Filtering type |

Among them, the scanning window, scanning interval, distribution mode, and filtering type are scanning parameters. Different scanning window and scanning interval, etc. can control the scanning frequency, and different scanning frequencies correspond to different power consumption.

At block 602: performing, by the first system, wireless signal scanning based on a scanning method indicated by the scanning parameter.

The first system obtains the scanning parameter from the wireless scanning request, and based on the scanning parameter, the first system operates a low-power wireless communication module to perform the wireless signal scanning.

In actual application, the user does not have the need to remotely control the external device every moment, i.e., the electronic device is not required to carry out signal scanning all the time. For example, when the external device is a vehicle, there is usually no need to remotely control the vehicle during the user's sleep or exercise, and the user usually walks a certain distance to reach the location of the vehicle before actually operating the vehicle. Therefore, in order to reduce the unnecessary signal scanning process while ensuring that the electronic device is able to scan the target wireless signal in time to connect to the external device, in some embodiments, a scanning strategy is provided in the electronic device, and the first system scans the wireless signal in accordance with the scanning strategy to realize the reduction of power consumption while satisfying the user's needs.

Specifically, the operation 602 includes the following steps.

Step 1: in a case where the scanning strategy is satisfied, performing, by the first system, the wireless signal scanning based on the scanning method indicated by the scanning parameter.

Accordingly, the device connection method provided by the embodiments of the present disclosure further includes the following steps.

Step 2: in a case where the scanning strategy is not satisfied, stopping, by the first system, the wireless signal scanning.

The first system obtains device usage data and determines whether the current usage state of the electronic device satisfies the condition of scanning the wireless signal in the scanning strategy. When the condition is satisfied, the first system performs the wireless signal scanning. When the condition is not satisfied, the first system stops scanning the wireless signal.

In some embodiments, the scanning strategy includes at least one of a sleep strategy, a wearing strategy, a movement strategy, a first pedometer strategy, and a second pedometer strategy.

The sleep strategy is configured to instruct the wireless signal scanning to be performed in a non-sleeping scenario. For example, the first system determines a sleep period of the user based on a sleep period setting operation of the user, or the first system determines whether the user is in a sleep state based on data such as heart rate, pulse, and time. In a case where the current moment is in a sleep period or it is determined that the user is in a sleep state, the first system determines that the current scene is a sleeping scenario, and based on the sleep strategy, the first system does not perform the wireless signal scanning in this case and starts performing the wireless signal scanning when the current scene enters a non-sleeping scenario.

The wearing strategy is configured to instruct the wireless signal scanning to be performed in a case where the electronic device is in a worn state. Since the user is able to remotely control the external device through the electronic device only when the user is wearing the electronic device, and is unable to remotely control the external device when not wearing the electronic device, it is an invalid behavior even if the electronic device establishes a communication connection with the external device when the user is not wearing the electronic device. Therefore, based on the wearing strategy, the first system monitors the device state of the electronic device in real time, performs the wireless signal scanning when the electronic device is in the worn state, and does not perform the wireless signal scanning when the electronic device is in a non-worn state.

The movement strategy is configured to instruct the wireless signal scanning to be performed in a non-motion scenario. The user may not need to use the external device during motion, and therefore, based on the motion strategy, the first system performs the wireless signal scanning only in the non-motion scenario. For example, the first system determines an exercise period of the user based on an exercise period setting operation from the user, or the first system determines whether the user is in an exercise state based on sensor data, heart rate, pulse rate, or device data of a connected exercise device. In a case where the current moment is in the exercise period or the user is in the exercise state, the first system determines that the current scene is a motion scenario, and based on the movement strategy, the first system does not perform the wireless signal scanning in this case and starts performing the wireless signal scanning when the current scene enters the non-motion scenario.

The pedometer strategy is configured to instruct the wireless signal scanning to be performed when an increment of the step count reaches a threshold value. The user usually needs to walk to the vicinity of the target external device before using the target external device, thus generating a certain number of steps (step count). For example, a pedometer is arranged in the electronic device, and the first system obtains the step count generated by the pedometer. In a case where the increment of the step count reaches the threshold value (e.g., 30 steps), the first system performs the wireless signal scanning.

The second pedometer strategy is configured to instruct the wireless signal scanning to be performed for a target duration of time after the step count stops changing. Since the user's walking is not necessarily generated by walking towards the target external device in need of using the target external device, when the first system does not scan and detect the target wireless signal and the user stops walking, it usually means that the user is not in need of using the target external device, and therefore, it is unnecessary for the first system to continue scanning for the wireless signal aimed at the target external device. However, the user may pause in the process of moving towards the target external device (for example, pausing to move forward in order to avoid other moving vehicles when moving towards the vehicle). Therefore, in order to avoid a situation in which the electronic device cannot connect to the target external device in a timely manner caused by the wireless signal scanning is immediately stopped when he/she pauses in the movement, the first system continues to performs the wireless signal scanning after the step count stops changing, and the first system stops the wireless signal scanning when the step count remains unchanged for a target duration (i.e., the user continues to be stationary during the target duration).

The above strategies may greatly reduce the length of time that the electronic device scans for wireless signals, significantly reduce power consumption, and will not affect the user experience. However, different external devices correspond to different actual use situations, for example, the user needs to use an exercise device in an exercise state, use a smart TV in a stationary state, and use a vehicle after non-sleeping, non-sporting, and walking a certain distance. In some embodiments, the electronic device provides an on/off function for each scanning strategy, and developers of different external devices can choose to enable or disable the corresponding strategies according to their own product characteristics and user needs. The developers may write strategy indication information in the device connection program, and when the second system runs the device connection program, it sends the strategy indication information to the first system, such that the first system of the electronic device can flexibly control the enabling and disabling of each strategy based on the strategy indication information.

In some embodiments, the second system indicates an on/off state of each scanning strategy by sending the strategy indication information to the first system, such that the first system performs the wireless signal scanning in accordance with the scanning method indicated by the scanning parameter when a target scanning strategy is satisfied. The above step 1 includes the following operations.

1. determining, by the first system, a target scanning strategy that is in an on state based on strategy indication information; where the strategy indication information is configured to indicate an on/off state of a scanning strategy, and the strategy indication information is provided by the second system.

In some embodiments, the wireless scanning request sent by the second system to the first system contains both the scanning parameter and the strategy indication information, or the second system sends the strategy indication information separately before sending the wireless scanning request or after sending the wireless scanning request, which is not limited herein.

2. in a case where the target scanning strategy is satisfied, performing, by the first system, the wireless signal scanning based on the scanning method indicated by the scanning parameter;

The above Step 2 further includes the following operation.

3. in a case where the target scanning strategy is not satisfied, stopping, by the first system, the wireless signal scanning.

TABLE 2

| Field Name | Data Type | Description |
|---|---|---|
| bleConnected | INT32 | Connection strategy, 1 on; 2 off |
| offWrist | INT32 | Wearing strategy, 1 on; 2 off |
| sleep | INT32 | Sleeping strategy, 1 on; 2 off |
| sport | INT32 | Movement strategy, 1 on; 2 off |
| step | INT32 | First pedometer strategy, 1 on; 2 off |
| stepNoChange | INT32 | Second step counting strategy, 1 on; 2 off |

Schematically, Table 2 illustrates the fields in the strategy indication information that are configured to indicate the on state of the respective connection strategies. When the value of the field bleConnected in the strategy indication information is 2, the first system always does not perform the wireless signal scanning. When the value of the fields bleConnected, offWrist, sleep, and sport in the strategy indication information is 1, and the value of the fields step and stepNoChange is 2, the first system performs the wireless signal scanning in a non-sleeping scenario, a non-motion scenario, and the electronic device is in a worn state, and the first system does not perform the wireless signal scanning in a situation in which the user is sleeping or in motion, or in a situation in which the user is not wearing the electronic device.

At block 603: obtaining, by the first system, a device identification included in the wireless signal.

Typically, a large number of wireless signals exist around the electronic device, and the electronic device is required to recognize the target wireless signal corresponding to the target external device from the wireless signals in order to establish a communication connection with the target external device. In some embodiments, the target external device is pre-set with an identification such that the wireless signal emitted by the target external device carries the target device identification, and an application in the target external device sends the target device identification to an application in the second system, either directly or indirectly (via a server), such that the electronic device stores the target device identification. The second system sends the target device identification to the first system such that the first system recognizes the target wireless signal.

The target device identification is an identification of the target external device, and the target device identification is configured to identify the target wireless signal of the target external device from the scanned wireless signals. Schematically, as shown in Table 1, the target device identification includes a factory identification and a Universally Unique Identifier (UUID) of the target external device.

In some embodiments, the wireless scanning request sent by the second system to the first system includes both the scanning parameter and the target device identification; or, the second system sends the target device identification separately before sending the wireless scanning request or after sending the wireless scanning request, which is not limited herein.

The first system performs the wireless signal scanning, reads data from each of the scanned wireless signals, and obtains the device identification contained therein. When a wireless signal does not contain a device identification, or the contained device identification is inconsistent with the target device identification, the first system determines that the wireless signal is not the target wireless signal, and continues scanning. At block 604: in a case where the device identification is a target device identification, sending, by the first system, a connection establishment request to the second system.

The target device identification is an identification of the target external device, and the target device identification is provided by the second system.

The first system obtains the device identification in the wireless signal, and when the wireless signal contains the device identification and the device identification is consistent with the target device identification in the wireless scanning request, the first system determines that the target wireless signal is scanned, and the transmitter of the target wireless signal is the target external device. The first system is required to inform the second system to establish a communication connection after scanning the target wireless signal, and therefore, the first system sends the connection establishment request to the second system. The connection establishment request contains the target wireless signal, or contains a target device parameter in the target wireless signal.

In some embodiments, when it is determined that the target wireless signal is scanned, the first system stops the wireless signal scanning to reduce power consumption, or, the first system continues the wireless signal scanning to ensure real-time acquisition of information.

At block 605: obtaining, by the second system, a target device parameter of the target external device based on the target wireless signal.

Since the information contained in the target wireless signal is usually expressed in binary form, the second system is required to parse the target wireless signal to obtain the target device parameter of the target external device based on the target wireless signal. The target device parameter is configured to indicate a communication mode, such as a MAC address, of the target external device.

In some embodiments, the second system parses the target wireless signal and obtains the device identification (e.g., a UUID) of the target external device. Although the first system performs a screening once and the first system sends only the identified target wireless signal to the second system, in order to avoid anomalies or misrecognition by the first system, the second system performs another identification comparison to ensure that the target wireless signal in the connection establishment request is the wireless signal emitted by the target external device.

Specifically, in some embodiments, the first system includes a low-power wireless communication module and a device service module, where the device service module is responsible for communicating with the second system, and the wireless communication module is responsible for signal scanning. The second system includes at least one device control application and a device connection module, where the device connection module is a program that comes with the second system of the electronic device, the device control application is downloaded and installed by the user based on his or her own needs; the device control application is responsible for executing an upper level operation of device connection as well as control, and the device connection module is responsible for communicating with the first system based on instructions from the device control application. When the second system is installed with the device control application, the second system adapts the interface to the device control application, such that different device control applications can each call the device connection module in the second system through the Software Development Kit (SDK).

The device connection module of the second system is arranged with a dual-system communication interface, and the first system and the second system communicate through the dual-system communication interface. The wireless communication module in the first system sends the connection establishment request to the device connection module in the second system through the dual-system communication interface, and after receiving the connection establishment request, the device connection module parses the target wireless signal in the connection establishment request, pulls up the process of the device control application in the second system, and sends the parsed target wireless signal to the device control application so as to cause the device control application to initiate the upper level operation of establishing the communication connection.

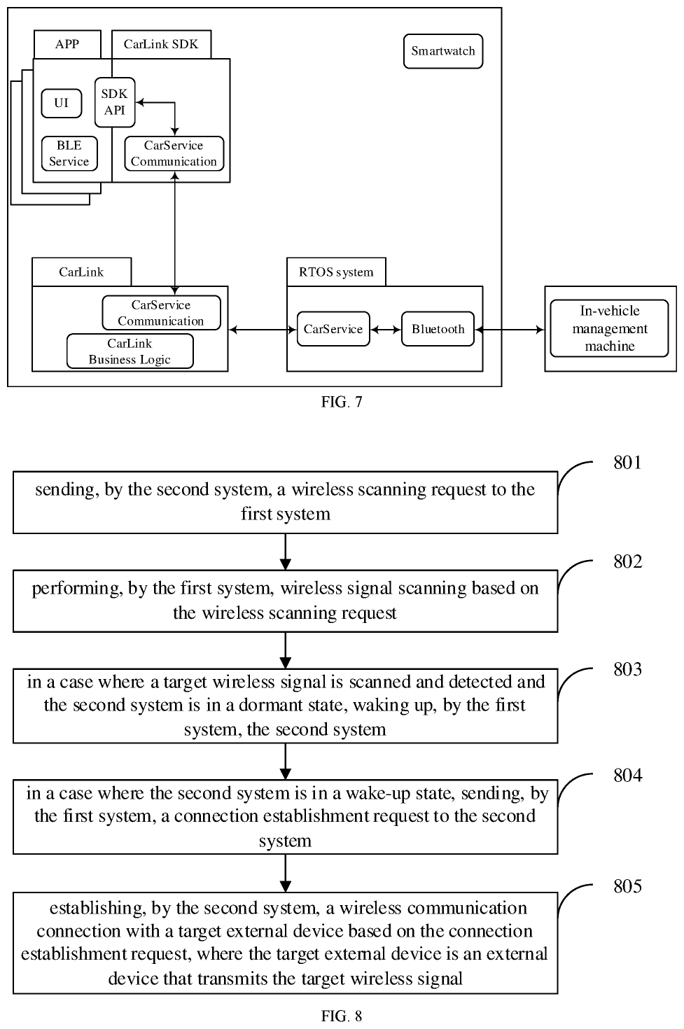

Schematically, as shown in FIG. 7, there is illustrated an architectural diagram of a process of establishing a communication connection between a smartwatch and an in-vehicle management machine. An intelligent system is arranged in the smartwatch, and an application (APP), for interacting with the in-vehicle management machine, in the intelligent system calls an in-vehicle management machine connectivity module (CarLink) in the intelligent system via an SDK, and sends the wireless scanning request to the device service module (CarService) in the RTOS system (first system) based on the dual-system communication interface in the CarLink (second system). The CarService calls the Bluetooth module in the RTOS (first system) to perform the wireless signal scanning. The CarService obtains the device identification from the wireless signals scanned by the Bluetooth module, and when the obtained device identification is consistent with the target device identification, the CarService determines that it has scanned the target wireless signal, and then sends the connection establishment request containing the target wireless signal to the CarLink (the second system) in the intelligent system through the dual-system communication interface. The CarLink (the second system) is responsible for parsing the target wireless signal and obtaining the target device parameter.

At block 606: sending, by the second system, the wireless connection request to the target external device based on the target device parameter.

In some embodiments, another wireless communication module is arranged in the second system, and the second system sends the wireless connection request to the target external device via its own wireless communication module based on the target device parameter. Alternatively, only one wireless communication module is arranged in the first system in the electronic device, the second system sends connection request data to the first system via the dual-system communication interface, and the first system sends the wireless connection request to the target external device via the wireless communication module based on the connection request data.

As shown in FIG. 7, the CarLink (the second system) pulls up the process of the APP and sends the target device parameter to the APP. The APP performs the upper level operation of establishing the communication connection, determines the way to establish the communication connection, and sends the connection request data to the CarService in the RTOS system (the first system) by calling the interface in the CarLink (the second system). Based on the connection request data, the CarService sends the wireless connection request to the in-vehicle management machine by calling the Bluetooth module in the RTOS system (the first system).

At block 607: in response to a request acceptance response from the target external device, establishing, by the second system, the wireless communication connection with the target external device.

After the electronic device sends the wireless connection request to the target external device, the target external device identifies the electronic device based on its own logic. When it is determined that the electronic device has wireless communication authority, the target external device sends a request acceptance response to the electronic device to inform the electronic device to establish the wireless communication connection.

For example, after receiving the wireless connection request, the in-vehicle management machine utilizes a key to identify the smartwatch. Upon determining that the smartwatch has wireless communication authority, the in-vehicle management machine sends the request acceptance response to the smartwatch. When the request acceptance response is received, the second system establishes the wireless communication connection with the in-vehicle management machine.

Specifically, the first system of the electronic device receives the request acceptance response and forwards the request acceptance response to the second system via the dual-system communication interface. The second system pulls up the process of the device control application, and the device control application performs the upper level operation of establishing the wireless communication connection and sends the connection establishment parameter to the first system via the dual-system communication interface, and the first system performs the task of connection establishment.

In the embodiments of the present disclosure, the second system sends the scanning parameter and the target device identification to the first system via the wireless scanning request, causing the first system to perform the signal scanning and identify the target wireless signal in accordance with the scanning method indicated by the scanning parameter; furthermore, multiple scanning strategies are provided in the first system, and the second system may send the strategy indication information indicative of the target scanning strategy to the first system, causing the first system to perform the signal scanning based on a suitable scanning strategy, thereby reducing ineffective scanning process and reducing power consumption of the device without affecting user experience.

The above embodiments illustrate a process of establishing a communication connection between an electronic device and a target external device. In some embodiment, after the communication connection is established between the electronic device and the target external device, the electronic device may communicate with the target external device through the communication connection, for example, to control the turning on and off of the target external device. The device connection method provided by the embodiments of the present disclosure further includes the following operations. [00160] sending, by the second system, a positioning broadcast, where the positioning broadcast is configured for the target external device to adjust a device state based on the received positioning broadcast.

In some embodiment, the positioning broadcast is a Bluetooth signal and/or a Wireless Fidelity (Wi-Fi) signal. In some embodiments, the positioning broadcast contains a device location of the electronic device, and the target external device determines a device distance based on the positioning broadcast as well as its own location; or, the positioning broadcast does not contain the device location, and the target external device determines the device distance based on the signal strength of the positioning broadcast.

In some embodiments, in a case where the communication connection is established between the second system and the target external device through the wireless communication module of the second system, the second system sends the positioning broadcast through the wireless communication module; in a case where no wireless communication module is arranged in the second system and the electronic device establishes the communication connection with the target external device through the wireless communication module of the first system, the second system sends, through the dual-system communication interface, a broadcasting request to the first system, and the first system sends the positioning broadcast based on the broadcast request.

When the target external device is an in-vehicle management machine, the device state includes an unlocked state and a locked state, and the positioning broadcast is configured for the in-vehicle management machine to determine a device distance from the electronic device based on the positioning broadcast. The above process of adjusting the device state further includes the following operations.
in a case where the device distance is less than a distance threshold, setting, by the in-vehicle management machine, the vehicle to an unlocked state; and
in a case where the device distance is greater than the distance threshold, setting, by the in-vehicle management machine, the vehicle to a locked state.

The target external device can be remotely turned on only when the user carries the electronic device close to the target external device. The target external device determines whether the electronic device has unlocking authority based on the device distance from the electronic device.

Schematically, the distance threshold is 5 m. When the electronic device establishes a communication connection with the in-vehicle management machine at a location 5 m away from the in-vehicle management machine, the electronic device sends a positioning broadcast, and the in-vehicle management machine determines that the device distance is greater than 5 m, in which case the locking state remains unchanged, and the electronic device continuously sends the positioning broadcast at a certain frequency. When the user moves with the electronic device to a position equal to or less than 5 m away from the in-vehicle management machine, the in-vehicle management machine receives the positioning broadcast and sets the vehicle to the unlocked state.

In the embodiments of the present disclosure, after the electronic device establishes a communication connection with the target external device, the second system obtains the unlocking authority of the device by sending the positioning broadcast, and the target external device unlocks the device when it is determined that the device distance is less than the distance threshold. Since the second system delivers the wireless signal scanning event to the first system for execution, the first system is able to wake up the second system to establish the communication connection and send the positioning broadcast when the target wireless signal is scanned, without the need for the second system to remain in the wake-up state, such that the user can carry the electronic device close to the target external device to realize non-sensorless unlocking of the target external device and carry the electronic device far away from the target external device to realize non-sensorless locking of the target external device, so as to simplify the operation of the user.

The dormant state is a state in which all running real-time data is stored on the hard disk and all unnecessary hardware is turned off to save power. In the dormant state, any operation on the device (other than a turning-on operation) is an invalid operation, and the device responds to the operation only when in the wake-up state. In some embodiment, in order to improve the endurance of the device, electronic devices are currently provided with a dormant mechanism, i.e., the system of the electronic device enters a dormant state when no user operation is received for a certain period of time (e.g., 5 s). The system in the dormant state does not perform background tasks. If this design in the related art is adopted, the system of the electronic device is unable to scan for wireless signals after entering the dormant state, which may result in the electronic device not being able to establish a communication connection with the external device in a timely manner, and it is necessary for the user to manually wake up the electronic device in order to be able to connect to the external device, such that the device connection efficiency is low, which affects the user experience.

In some embodiments, the operating mode of the electronic device includes a performance mode, a hybrid mode, and a low-power mode. In the performance mode, the second processor and the first processor are both maintained in the wake-up state (accordingly, the first system and the second system are in the wake-up state); in the low-power mode, only the first processor is maintained in the wake-up state, and the second processor is maintained in an off state (i.e., the first system is in the wake-up state and the second system is in the off state); in the hybrid mode, the second processor is in a standby state while events being processed through the first system, and can be switched between the dormant and wake-up states (i.e., when the first system is in the wake-up state, the second system can be in both the wake-up state and the dormant state).

In some embodiments, in the wake-up state, the system-related data is cached in a Random Access Memory (RAM) for running the system-related data at any time. In the dormant state, most of the hardware modules of the processor are turned off, and the system-related data is stored in a hard disk Read-Only Memory (ROM) and is and written to the memory by the hard disk when it switches to the wake-up state.

Unlike a smartphone, which is an electronic device with strong interaction properties, the electronic device in the embodiments of the present disclosure, as an auxiliary device, has only weak interaction with the user in most of the usage scenarios. For example, the user only lifts the wrist to look at the time through the smartwatch in most scenarios. Therefore, the electronic device controls the second processor to be in the dormant state (the second system is in the dormant state) when the electronic device processes an event through the first system, thereby reducing the overall power consumption of the electronic device.

Referring to FIG. 8, FIG. 8 is a flowchart of a device connection method according to further other embodiments of the present disclosure. The present embodiments are illustrated as an example in which the method is applied to an electronic device, and the electronic device supports operation of a first system and a second system. The method may include the following operations at blocks illustrated in FIG. 8.

At block 801: sending, by the second system, a wireless scanning request to the first system.

Since the operating power consumption of the first system is lower than the operating power consumption of the second system, in conjunction with the consideration of device life-span, the first system is in a wake-up state for a long time during the operation of the electronic device, and the second system is switched from a dormant state to a wake-up state only when it is necessary to process a specific event. In the embodiments of the present disclosure, in order to ensure that the communication connection between the electronic device and the external device can still be maintained when the second system is in the dormant state or when the process of a target application run by the second system is ended, when the second system, or, the target application run by the second system, is required to establish a communication connection with the external device, the second system sends a wireless scanning request to the first system in the wake-up state, requesting the first system to perform wireless signal scanning instead of the second system or the target application.

At block 802: performing, by the first system, wireless signal scanning based on the wireless scanning request.

The specific implementation of operations 801 and 802 can be referred to operations 401 and 402 above, and the embodiments of the present disclosure will not be repeated herein.

At block 803: in a case where a target wireless signal is scanned and detected and the second system is in a dormant state, waking up, by the first system, the second system.

In some embodiment, the second system sends the wireless scanning request to the first system after receiving a device connection operation. When the wireless scanning request is sent, the second system suspends the device connection task, enters the dormant state when no user operation is received within a preset length of time, and switches a device control application to the background and stops operation when an enable operation for another application is received.

After scanning and detecting the target wireless signal, the first system determines a system state of the second system. When the second system is in the dormant state, the first system wakes up the second system and pulls up a process of the device control application.

At block 804: in a case where the second system is in a wake-up state, sending, by the first system, a connection establishment request to the second system.

When it is determined that the second system is in the wake-up state, the first system sends the connection establishment request to the second system to allow the second system to continue with the device connection task.

In some embodiments, the first system operates at a lower power consumption than the second system, such that the electronic device is able to further reduce the overall power consumption of the device by hibernating the high-power system and relying on the low power system for signal scanning.

At block 805: establishing, by the second system, a wireless communication connection with a target external device based on the connection establishment request, where the target external device is an external device that transmits the target wireless signal.

The specific real-time manner of operation 805 may refer to operation 404 above, and the embodiments of the present disclosure will not be repeated herein.

In the embodiments of the present disclosure, since the second system delivers the signal scanning event to the first system for execution, the second system may enter the dormant state during the wireless signal scanning being performed by the first system without continuously maintaining the wake-up state, i.e., the electronic device is still capable of signal scanning during the dormancy of the second system, and the second system is woken up to continue to carry out the device connection after scanning of the target wireless signal by the first system. In this way, the device power consumption is reduced without affecting the device connection efficiency and user experience.

After the electronic device establishes a communication connection with the target external device, it is further necessary to maintain the communication connection to ensure the quality of the subsequent communication. Usually, the maintenance of the communication connection is required to be realized by relying on the communication parties to continuously send heartbeat packets, and thus the systems of the communication parties are required to maintain the wake-up state. In some embodiments, the first system and the second system of the electronic device provided in the embodiments of the present disclosure share a wireless communication component of the electronic device, and the device connection method further includes the following steps.

Step 3: sending, by the second system, a heartbeat packet sending request to the first system.

Step 4: sending, by the first system, a heartbeat packet to the target external device based on the heartbeat packet sending request; where the heartbeat packet is configured to maintain the wireless communication connection with the target external device.

After the communication connection is established between the electronic device and the target external device, the electronic device interacts with the target external device through the communication connection, and in order to maintain the communication connection, the heartbeat packet is required to be sent between the electronic device and the target external device in accordance with a certain time interval.

In some embodiments, the first system and the second system share the wireless communication component of the electronic device, the second system sends the heartbeat packet sending request to the first system, and the first system is responsible for continuously sending the heartbeat packet to the target external device. Upon receiving the heartbeat packet sending request, the first system sends the heartbeat packet to the target external device according to a heartbeat packet sending method indicated by the heartbeat packet sending request. In a subsequent process, even if the second system enters the dormant state or the process of the device control application is ended, the first system is still able to continue to send the heartbeat packet to maintain the communication connection between the electronic device and the target external device.

In some embodiments, the heartbeat packet sending request contains a heartbeat packet parameter required for sending the heartbeat packet, which may include a heartbeat period, a heartbeat packet data format, etc.

In some embodiments, the first system generates the heartbeat packet via a heartbeat packet application and invokes the communication component to send the heartbeat packet to the external device. The communication component of the electronic device is mounted on a processor or processor core running the first system, and therefore, the communication component can be invoked to send the heartbeat packet to the external device when the first system is in the wake-up state.

In a schematic example, the smartwatch supports running RTOS and Android systems, and when a first vehicle control application in the Android system is required to maintain a Bluetooth communication with a second vehicle control application in the in-vehicle management machine (for device state exchange), the first vehicle control application sends a first heartbeat packet sending request to the heartbeat packet application in the RTOS.

In order to make the electronic device aware of the device state of the external device and to avoid the electronic device from actively disconnecting from the communication connection, the external device is required to send a heartbeat feedback packet to the electronic device through the communication connection after receiving the heartbeat packet. Therefore, the first system is responsible for receiving the heartbeat feedback packet in addition to being responsible for sending the heartbeat packet. In some embodiments, the heartbeat feedback packet contains a device state of the external device, and the frequency at which the external device sends the heartbeat feedback packet may be the same or different from the frequency at which the electronic device sends the heartbeat packet.

In some embodiments, the heartbeat packet sending request further contains a feedback packet processing strategy, and the first system processes the heartbeat feedback packet according to the feedback packet processing strategy.

In some embodiments of the present disclosure, when the second system is required to maintain a communication connection with the external device, the second system sends the heartbeat packet sending request to the first system, and the first system sends the heartbeat packet to the external device based on the heartbeat packet sending request and receives the heartbeat feedback packet sent by the external device. In a case where the second system is in a dormant state, or, where a process of an application in the second system that is required to maintain data communication with the external device is ended, the process of heartbeat packet sending can be maintained between the electronic device and the external device, thereby ensuring the availability of the subsequent communication connection between the electronic device and the external device. Moreover, when the second system is a high-power system and the first system is a low-power system, the communication connection is maintained by the low-power system, and the second system can enter a dormant state, which helps to reduce the power consumption of the electronic device and improve the endurance of the electronic device.

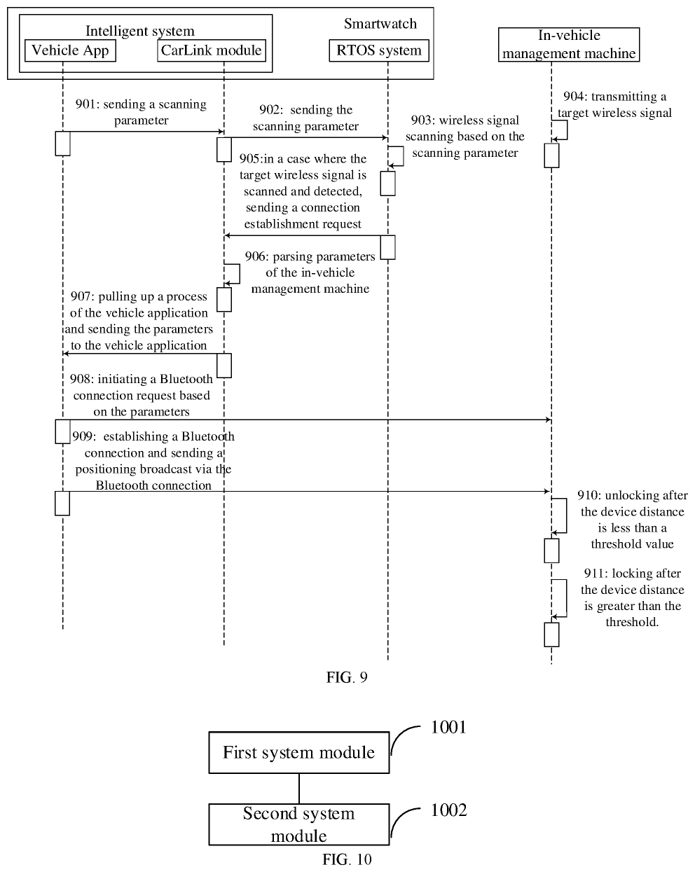

Based on the various embodiments described above, in a schematic example, a process of establishing a communication connection, maintaining a communication connection, and controlling a vehicle state between a smartwatch and an in-vehicle management machine is shown in FIG. 9.

Step 901, a vehicle application in a smart system sends a scanning parameter to a CarLink module in the smart system.

Step 902, the CarLink module in the intelligent system sends the scanning parameter to a RTOS system.

Step 903, the RTOS system performs wireless signal scanning based on the scanning parameter.

Step 904, the in-vehicle management machine transmits a target wireless signal.

Step 905, in a case where the target wireless signal is scanned and detected, the RTOS system sends a connection establishment request to the CarLink module in the intelligent system.

Step 906, the CarLink module in the intelligent system parse parameters of the in-vehicle management machine.

Step 907, the CarLink module in the intelligent system pulls up a process of the vehicle application and sends the parameters of the in-vehicle management machine to the vehicle application.

Step 908, the vehicle application in the intelligent system initiates a Bluetooth connection request to the in-vehicle management machine based on the parameters of the in-vehicle management machine.

Step 909, the vehicle application in the intelligent system establishes a Bluetooth connection and sends a positioning broadcast to the in-vehicle management machine via the Bluetooth connection.

Step 910, the in-vehicle management machine unlocks the vehicle after the device distance is less than a threshold value.

Step 911, the in-vehicle management machine locks the vehicle after the device distance is greater than the threshold.

Referring to FIG. 10, FIG. 10 is a structural block diagram of a device connection apparatus according to some embodiments of the present disclosure. The apparatus may be realized as all or part of an electronic device by software, hardware, or a combination of both. The apparatus includes the following elements.
a second system module 1002, configured to send a wireless scanning request to a first system module 1001;
the first system module 1001, configured to perform wireless signal scanning based on the wireless scanning request;
where the first system module 1001 is further configured to send a connection establishment request to the second system module 1002 in a case where a target wireless signal is scanned and detected;

The second system module 1002 is further configured to establish a wireless communication connection with a target external device based on the connection establishment request, where the target external device is an external device that transmits the target wireless signal.

In some embodiments, the wireless scanning request contains a scanning parameter;
the first system module 1001 is further configured to perform the wireless signal scanning based on a scanning method indicated by the scanning parameter.

In some embodiments, the first system module 1001 is arranged with a scanning strategy, and the scanning strategy is configured to indicate a condition to be satisfied when performing the wireless signal scanning;
the first system module 1001 is further configured to perform the wireless signal scanning based on a scanning method indicated by the scanning parameter in a case where the scanning strategy is satisfied;
the first system module 1001 is further configured to stop the wireless signal scanning in a case where the scanning strategy is not satisfied.

In some embodiments, the scanning strategy includes at least one of a sleep strategy, a wearing strategy, a movement strategy, a first pedometer strategy, and a second pedometer strategy;
the sleep strategy is configured to instruct the wireless signal scanning to be performed in a non-sleeping scenario;
the wearing strategy is configured to instruct the wireless signal scanning to be performed in a case where the electronic device is in a worn state;
the movement strategy is configured to instruct the wireless signal scanning to be performed in a non-motion scenario;
the first pedometer strategy is configured to instruct the wireless signal scanning to be performed when an increment of the step count reaches a threshold value;
the second pedometer strategy is configured to instruct the wireless signal scanning to be performed for a target duration of time after the step count stops changing.

In some embodiments, the first system module 1001 is further configured to:
determine a target scanning strategy that is in an on state based on strategy indication information; where the strategy indication information is configured to indicate an on/off state of a scanning strategy, and the strategy indication information is provided by the second system module 1002;
in a case where the target scanning strategy is satisfied, perform the wireless signal scanning based on the scanning method indicated by the scanning parameter;
in a case where the target scanning strategy is not satisfied, stop the wireless signal scanning.

In some embodiments, the first system module 1001 is further configured to:
obtain a device identification included in the wireless signal;
in a case where the device identification is a target device identification, send the connection establishment request to the second system module 1002; where the target device identification is an identification of the target external device, and the target device identification is provided by the second system module 1002.

In some embodiments, the connection establishment request includes the target wireless signal;
the second system module 1002 is further configured to obtain a target device parameter of the target external device based on the target wireless signal;
the second system module 1002 is further configured to send a wireless connection request to the target external device based on the target device parameter;
the second system module 1002 is further configured to establish the wireless communication connection with the target external device in response to a request acceptance response from the target external device.

In some embodiments, the second system module 1002 is further configured to:
send a positioning broadcast, where the positioning broadcast is configured for the target external device to adjust a device state based on the received positioning broadcast.

In some embodiments, the target external device is an in-vehicle management machine, and the positioning broadcast is configured for the in-vehicle management machine to determine a device distance from the electronic device based on the positioning broadcast;
in a case where the device distance is less than a distance threshold, the in-vehicle management machine sets the vehicle to an unlocked state; and
in a case where the device distance is greater than the distance threshold, the in-vehicle management machine sets the vehicle to a locked state.

In some embodiments, the first system module 1001 is further configured to:
wake up the second system module 1002 in a case where the target wireless signal is scanned and detected and the second system module 1002 is in a dormant state;
send the connection establishment request to the second system module 1002 in a case where the second system module 1002 is in a wake-up state,

In some embodiments, the first system module 1001 and the second system module 1002 share a wireless communication component of the electronic device;
the second system module 1002 is further configured to send a heartbeat packet sending request to the first system module 1001;
the first system module 1001 is further configured to send a heartbeat packet to the target external device based on the heartbeat packet sending request; where the heartbeat packet is configured to maintain the wireless communication connection with the target external device.

In some embodiments, the operating power consumption of the first system module 1001 is lower than the operating power consumption of the second system module 1002.

In summary, in the embodiments of the present disclosure, the second system sends a wireless scanning request to the first system, such that the first system is responsible for signal scanning, and the electronic device is still able to scan the wireless signals of the external device through the first system even when the second system enters into the dormant state; the first system sends a notification to the second system when scanning and detecting the target wireless signal, such that there is no need for the second system to remain in the wake state for a long period of time and the device connection process can still be carried out.

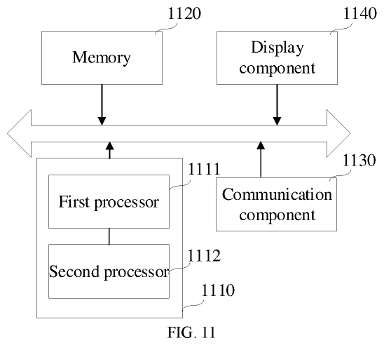

Referring to FIG. 11, FIG. 11 is a structural block diagram of an electronic device according to some embodiments of the present disclosure. The electronic device of the present disclosure may include one or more of the following components: a processor 1110 and a memory 1120.

In some embodiments, the processor 1110 includes at least a first processor 1111 and a second processor 1112, where the first processor 1111 is configured to run a first system and the second processor 1112 is configured to run a second system; the power consumption of the first processor 1111 is lower than the power consumption of the second processor 1111; the performance of the first processor 1111 is lower than the performance of the second processor 1112. The processor 1110 utilizes various interfaces and wiring to connect various portions within the electronic device to perform various functions of the electronic device and process data by running or executing instructions, programs, code sets, or sets of instructions stored in the memory 1120, and by calling up data stored in the memory 1120. In some embodiments, the processor 1110 may be processor 1110 may be implemented in a form of hardware by at least one of Digital Signal Processing (DSP), Field-Programmable Gate Array (FPGA), and Programmable Logic Array (PLA). The processor 1110 may integrate one or a combination of a Central Processing Unit (CPU), a Graphics Processing Unit (GPU), a Neural-network Processing Unit (NPU), and a modem, etc. The CPU is mainly configured for handling the operating system, user interface, and application programs, etc.; the GPU is configured for rendering and drawing the content to be displayed by the touch screen; the NPU is configured for realizing the Artificial Intelligence (AI) function; and the modem is configured for handling the wireless communication. It is to be understood that the modem may not be integrated into the processor 1110 and be implemented through a chip alone.

The memory 1120 may include Random Access Memory (RAM) or may include Read-Only Memory (ROM). In some embodiments, the memory 1120 includes a non-transitory computer-readable storage medium. The memory 1120 may be configured to store instructions, programs, code, code sets, or instruction sets. The memory 1120 may include a storage program area and a storage data area, where the storage program area may store instructions for implementing the operating system, instructions for at least one function (e.g., a touch function, a sound playback function, an image playback function, etc.), instructions for implementing each of the method embodiments described above, etc., and the storage data area may store data created based on the use of the electronic device (e.g., audio data, phone book), etc.

The electronic device in the embodiments of the present disclosure further includes a communication component 1130 and a display component 1140, where the communication component 1130 may be a Bluetooth component, a Wi-Fi component, a Near Field Communication (NFC) component, etc., for communicating with an external device (a server or other terminal device) via a wired or wireless network; the display component 1140 is configured for performing a graphical user interface presentation, and/or, receiving user interaction.

The embodiments of the present disclosure further provide a computer-readable storage medium storing at least one instruction, the at least one instruction being loaded and executed by a processor to cause an electronic device to implement the device control method as described in various embodiments above.

The embodiments of the present disclosure further provide a computer program product or computer program, the computer program product or computer program including computer instructions; where the computer instructions are stored in a computer-readable storage medium; a processor of the electronic device reads the computer instructions from the computer-readable storage medium, and the processor executes the computer instructions such that the electronic device performs the device control method as described in various embodiments above.

It should be appreciated by those skilled in the art that, in one or more of the above examples, the functionality described in the embodiments of the present disclosure may be implemented using hardware, software, firmware, or any combination thereof. When implemented using software, the functions may be stored in a computer-readable storage medium or transmitted as one or more instructions or code on the computer-readable storage medium. The computer-readable storage medium includes a computer storage medium and a communication medium, where the communication medium includes any medium that facilitates the transmission of a computer program from one location to another. The storage medium may be any available medium to which a general purpose or specialized computer has access.

The foregoing are only some embodiments of the present disclosure and are not intended to limit the present disclosure, and any modifications, equivalent substitutions, improvements, etc. made within the spirit and principles of the present disclosure shall be included within the scope of the present disclosure.

What is claimed is:

1. A device connection method, performed by an electronic device; wherein the electronic device supports operation of a first system and a second system;
wherein the device connection method comprises:
sending, by the second system, a wireless scanning request to the first system;
performing, by the first system, wireless signal scanning based on the wireless scanning request;
sending, by the first system, a connection establishment request to the second system a case where a target wireless signal is scanned and detected; and
establishing, by the second system, a wireless communication connection with a target external device based on the connection establishment request; wherein the target external device is an external device that transmits the target wireless signal.

2. The method according to claim 1, wherein a scanning parameter is included in the wireless scanning request, and the performing, by the first system, wireless signal scanning based on the wireless scanning request comprises:
performing, by the first system, the wireless signal scanning based on the scanning parameter.

3. The method according to claim 2, wherein the performing, by the first system, the wireless signal scanning based on the scanning parameter comprises performing, by the first system, the wireless signal scanning based on a scanning method indicated by the scanning parameter.

4. The method according to claim 3, wherein the first system is arranged with a scanning strategy, and the scanning strategy is configured to indicate a condition to be satisfied when performing the wireless signal scanning; the performing, by the first system, the wireless signal scanning based on a scanning method indicated by the scanning parameter comprises:
in a case where the scanning strategy is satisfied, performing, by the first system, the wireless signal scanning based on the scanning method indicated by the scanning parameter;
the method further comprises:
in a case where the scanning strategy is not satisfied, stopping, by the first system, the wireless signal scanning.

5. The method according to claim 4, wherein the scanning strategy comprises at least one of a sleep strategy, a wearing strategy, a movement strategy, a first pedometer strategy, and a second pedometer strategy;
the sleep strategy is configured to instruct the wireless signal scanning to be performed in a non-sleeping scenario;
wherein the wearing strategy is configured to instruct the wireless signal scanning to be performed in a case where the electronic device is in a worn state;
the movement strategy is configured to instruct the wireless signal scanning to be performed in a non-motion scenario;
the first pedometer strategy is configured to instruct the wireless signal scanning to be performed in a case where an increment of a step count reaches a threshold value; and
the second pedometer strategy is configured to instruct the wireless signal scanning to be performed in a case where a target duration of time is reached after the step count stops changing.

6. The method according to claim 4, wherein the in a case where the scanning strategy is satisfied, performing, by the first system, the wireless signal scanning based on the scanning method indicated by the scanning parameter comprises:
determining, by the first system, a target scanning strategy that is in an on state based on strategy indication information; wherein the strategy indication information is configured to indicate an on/off state of the scanning strategy, and the strategy indication information is provided by the second system; and
in a case where the target scanning strategy is satisfied, performing, by the first system, the wireless signal scanning based on the scanning method indicated by the scanning parameter;
wherein the in a case where the scanning strategy is not satisfied, stopping, by the first system, the wireless signal scanning comprises:
in a case where the target scanning strategy is not satisfied, stopping, by the first system, the wireless signal scanning.

7. The method according to claim 1, wherein,
the sending, by the first system, a connection establishment request to the second system a case where a target wireless signal is scanned and detected comprises:
obtaining, by the first system, a device identification included in the wireless signal; and
in a case where the device identification is a target device identification, sending, by the first system, the connection establishment request to the second system; wherein the target device identification is an identification of the target external device, and the target device identification is provided by the second system.

8. The method according to claim 1, wherein the connection establishment request includes the target wireless signal;
the establishing, by the second system, a wireless communication connection with a target external device based on the connection establishment request comprises:
obtaining, by the second system, a target device parameter of the target external device based on the target wireless signal;
sending, by the second system, a wireless connection request to the target external device based on the target device parameter; and
in response to a request acceptance response from the target external device, establishing, by the second system, the wireless communication connection with the target external device.

9. The method according to claim 1, further comprising:
sending, by the second system, a positioning broadcast; wherein the positioning broadcast is configured for the target external device to adjust a device state based on the positioning broadcast.

10. The method according to claim 8, wherein the target external device is an in-vehicle management machine of a vehicle, and the positioning broadcast is configured for the in-vehicle management machine to determine a device distance from the electronic device based on the positioning broadcast;
in a case where the device distance is less than a distance threshold, the in-vehicle management machine sets the vehicle to an unlocked state; and
in a case where the device distance is greater than the distance threshold, the in-vehicle management machine sets the vehicle to a locked state.

11. The method according to claim 1, wherein the sending, by the first system, a connection establishment request to the second system a case where a target wireless signal is scanned and detected comprises:
in a case where the target wireless signal is scanned and detected and the second system is in a dormant state, waking up, by the first system, the second system; and
in a case where the second system is in a wake-up state, sending, by the first system, the connection establishment request to the second system.

12. The method according to claim 1, wherein the first system and the second system share a wireless communication component of the electronic device;
the method further comprises:
sending, by the second system, a heartbeat packet sending request to the first system; and
sending, by the first system, a heartbeat packet to the target external device based on the heartbeat packet sending request; wherein the heartbeat packet is configured to maintain the wireless communication connection with the target external device.

13. The method according to claim 12, wherein the method further comprises:
receiving, by the first system, a heartbeat feedback packet sent from the target external device; wherein the heartbeat feedback packet comprises a device state of the target external device.

14. The method according to claim 13, wherein the heartbeat packet sending request further comprises a feedback packet processing strategy, and the first system is configured to process the heartbeat feedback packet according to the feedback packet processing strategy.

15. The method according to claim 1, wherein an operating power consumption of the first system is lower than an operating power consumption of the second system.

16. The method according to claim 1, wherein,
the first system is configured to process events at least one of: dial display, notification message display, wireless signal scanning, sending and receiving of signals and data; and/or,
the second system is configured to process events at least one of: incoming call answering, message replying, dial editing, function setting, communication upper layer business.

17. The method according to claim 1, wherein the establishing, by the second system, a wireless communication connection with a target external device based on the connection establishment request, comprises:
sending, by the second system, connection request data to the first system; and
sending, by the first system, a wireless connection request to the target external device via a wireless communication module based on the connection request data.

18. The method according to claim 1, wherein,
the electronic device is a smartwatch and the external device is an in-vehicle management machine.

19. An electronic device, comprising a processor and a memory; wherein the electronic device supports operation of a first system and a second system; the memory stores at least one instruction, the at least one instruction being configured to be executed by the processor to cause the electronic device to perform:
sending, by the second system, a wireless scanning request to the first system;
performing, by the first system, wireless signal scanning based on the wireless scanning request;
sending, by the first system, a connection establishment request to the second system in a case where a target wireless signal is scanned and detected; and
establishing, by the second system, a wireless communication connection with a target external device based on the connection establishment request; wherein the target external device is an external device that transmits the target wireless signal.

20. A non-transitory computer-readable storage medium for an electronic device, storing at least one instruction; wherein the electronic device supports operation of a first system and a second system; the at least one instruction is configured to be executed by a processor to cause an electronic device to perform:
sending, by the second system, a wireless scanning request to the first system;
performing, by the first system, wireless signal scanning based on the wireless scanning request;
sending, by the first system, a connection establishment request to the second system in a case where a target wireless signal is scanned and detected; and
establishing, by the second system, a wireless communication connection with a target external device based on the connection establishment request; wherein the target external device is an external device that transmits the target wireless signal.
